(19) United States
(12) Patent Application Publication
(10) Pub. No.: US 2004/0008382 A1
(43) Pub. Date: Jan. 15, 2004

(54) System and method for error diffusion screening with parallel processing

(76) Inventor: Thomas Samuel Barbalet, Wilmslow (GB)

Correspondence Address: DARBY & DARBY P.C., Post Office Box 5257, New York, NY, 10150-5257, US

(21) Appl. No.: 10/260,702

(22) Filed: Sep. 30, 2002

Related U.S. Application Data
(60) Provisional application No. 60/394,731, filed on Jul. 9, 2002.

(51) Int. Cl. H04N 1/405; G06F 9/28

(52) U.S. Cl. 358/3.03; 382/304

(57) ABSTRACT

A system and method for error diffusion screening with parallel processing, in which the calculation of an error diffused output image is divided into two distinct processes. A first process is used to calculate the tone value for an output pixel based only on a corresponding input pixel value. The second process is used to the manage distribution and application of the error terms to output values. The error arising from each pixel is apportioned among its neighbors entirely within the error array. As a result, the two processes run simultaneously, provided that the second process does not start to use the error term for any particular pixel until the first process has complete the calculation of the error term.

### RELATED APPLICATIONS

The invention relates to, and claims priority of, U.S. Provisional Patent Application Serial No. 60/394,731 filed on Jul. 9, 2002, having the same title as the present invention, which is incorporated herein by reference.

### BACKGROUND OF THE INVENTION

1. Field of the Invention

The present invention generally relates to the field of computer graphics and, more particularly, to error diffusion screening with parallel processing.

2. Description of the Related Art

Digital halftone screening is a mechanism for reproducing an image based on the use of less bits per pixel than available in an original image.

Very often only one bit will be available in an output image. That is, each pixel can only be either colored or not colored. In contrast, the original image will typically be continuous tone with eight or more bits per pixel, though often at a lower resolution than the output.

Screening utilizes the eye's natural tendency to integrate small dots over an area. In general, a person will perceive a tone (a shade of gray) from the screened image approximately according to the ratio of colored dots to the total number of dots over an area.

When more than two, but still a small number of tonal values is available, the eye of a viewer still perceives the tone from a group of adjacent dots and white space. However, the values that are implicitly integrated vary from point-to-point.

In principle, there are many possible arrangements of dots that can achieve the same visual result. In a perfect system, this is because the perceived tone depends on the ratio of colored dots and their densities, and not on the actual arrangement of the dots. There are many different classes of screening algorithms and these can be characterized by the way in which they arrange the dots.

A conventional halftone screen clusters colored pixels together in discrete areas called cells. This has the effect of making the dots more noticeable to the human eye. As a result, conventional halftone screens require the ability to reproduce small pixels at high resolutions to achieve high quality images. On the other hand, the ability of such screens to pre-compute and tessellate cells (i.e., group together cells) over an area is efficient; the clumping of dots allows for optional control over printing processes. In addition, the earlier and familiar physical manifestations produced using glass gratings and film are approximated by computational halftoning.

More recently, stochastic methods have been used with some success. These methods distribute the colored pixels more randomly, with a greater or lesser control over dot placement according to the particular algorithm. The key feature, here, is that the correct ratio of colored dots to white space should be achieved. Because smaller dot clusters are used, such methods can be used on lower resolution devices, such as ink-jet printers. However, they have the disadvantage of yielding an image that appears grainy.

Another method is error diffusion screening. Error diffusion screening has been more successful when applied at lower resolutions. It is also easy to apply where more than one-bit per pixel is available in the resultant image. Error diffusion screening involves choosing the tone value of a result such that the tone value is the closest available from among the smaller number of levels in the output to the tone value indicated by the corresponding input pixel. This applies whether the result chosen is 0 or 1 in a bi-level system, or whether the result is chosen from a larger number of possible tone values.

The difference between the original input value and the output result at some pixel is an error term that can be either positive or negative. For example, for a 3-level output, the possible output values (normalized in the range 0 to 1) are 0, 0.5 and 1. An input value of 0.8 would select 1 as the output with an error of −0.2. An input of 0.6 would select 0.5 in the output with an error of +0.1.

Usually, a resultant value for a pixel that is larger or smaller than the corresponding input is selected to compensate for a positive or a negative error value. The error is then apportioned between one or more neighboring pixels and added to the input pixel value at each of the one or more neighboring pixels. The nearest available output value is later chosen for these pixels, taking into account the error acquired from all of the neighbors that contribute to the pixel. In practice, the error values or sums are usually stored, and pixels are obtained across scan lines and down the page.

In principle, distribution of the error to immediate neighbors is not required. This is true as long as the effect is not so far distant that the perception of the tone over a small area is lost.

In practice, the error from a pixel is passed to neighbors in the direction in which the pixels are being computed (usually to the right and downwards) to avoid revisiting pixels whose output values were previously computed. Errors that cannot be forwarded to a neighboring pixel are discarded because they are off the edge of the page or image.

A method for error diffusion screening is disclosed by R. W. Floyd and L. Steinberg in “Adaptive Algorithm for Spatial Grey Scale” [SID Int. Sym. Digest of Technical Papers, pg. 36-37, 1975]. As shown in FIG. 1, the error from a pixel is distributed to the four immediate neighbors to the right, below-right, below, and below-left of the pixel being considered in the proportions of 7/16, 1/16, 5/16, and 3/16 respectively.

In accordance with the Floyd-Steinberg method, input and output values are both represented in the same (integer) number ranges, by the arrays input and output indexed by pixel co-ordinates x, y. The output values are constrained such that they only utilize a small number of those values, evenly spaced (by output_step) to the extent possible using integer numbers. As a result, the small number of levels permitted in the output is represented by the integer numbers.

This is represented by the following sequence of steps, in which:

remainder = input (x,y) MODULUS output_step
if remainder >=output_step / 2 then

error_term = remainder − output_step

else

error_term = remainder
output (x, y) = input (x, y) − error_term
input (x+1, y)=input (x+1, y) + error_term * 7/16
input (x+1, y+1) = input (x+1, y+1) + error_term * 1/16
input (x, y+1) = input (x, y+1) + error_term * 5/16
input (x−1, y+1) = input (x−1, y+1) + error_term * 3/16

where

output_step = ( input_levels / (output_levels − 1)) − 1

As an example, for an 8-bit per pixel original, there are 256 input levels. As a result, for a 3 level output, the step (i.e., the output_step) is 127 from one permitted output value to the next when scaled to match the range of the input values.

Many variations of error diffusion screening based on the Floyd-Steinberg method are possible. For example, different distributions of error terms can be used. In addition, distribution patterns may be varied according to content or by way of a controlled random selection.

Error diffusion screening can produce excellent results. However, it is computationally expensive. The calculation of the nearest output value that approximates the corresponding input value is costly because it involves a modulus operation (in effect, a division).

Furthermore, while conventional clustered-dot screening can be applied simultaneously to different areas of the picture, it is not possible to do so in the Floyd-Steinberg method, as well as in other error diffusion techniques. This is because each pixel depends on the error terms that arise from all its predecessors. Therefore, all of the pixels must be calculated first. As a result, it is not possible to make optimal usage of multiple, parallel processors when computing the screening for an error-diffused page, where each processor is working on a different part of the image.

For the same reason, small changes made to the picture require the whole picture to be re-screened rather than simply re-screening the affected region, such as where a small element is to be moved across a fixed background, such as a character in a video game.

It is therefore apparent that there is a need for an improved error diffusion screening method that advantageously utilizes parallel processing architectures, and with which small modifications can be made to an image without the requirement to re-screen an entire image.

### SUMMARY

The invention is a system and method for error diffusion screening with parallel processing. In accordance with the invention, the calculation of an error diffused output image is divided into two distinct processes. The first process is used to calculate the tone value for an output pixel based only on a corresponding input pixel value. The error term arising for that pixel based on the difference between input and output pixel values is also computed and stored using only the first process. An array of output pixels whose values are simply the permitted output values closest to the corresponding inputs and an array of error terms for those pixels are produced.

The second process is used to manage distribution and application of the error terms to output values. The error arising from each pixel is apportioned among its neighbors entirely within the error array. As a result, the two processes run simultaneously, provided that the second process does not start to use the error term for any particular pixel until the first process has complete the calculation of the error term.

In certain cases, it is not necessary to use an array for the error terms that have an element for every pixel on the entire image or page. This is because the effect of the error propagation is very small beyond a few neighboring pixels. Here, the absolute value of the maximum error arising from any input value is half of the amount represented by a level. For example, in a 3-level system, where the normalized outputs are 0, 0.5 and 1, the maximum error is half of 0.5 (i.e. 0.25). The error contributed to any pixel (when applied in accordance with Floyd Steinberg's proportions) is 1/16 from the upper left neighbor, 5/16 from the pixel above, 3/16 from the pixel above and to the right, and 7/16 from the left. (see FIG. 2). These errors are all accumulated by a pixel and add up to 1. Therefore, the maximum error from all neighbors transferred into a pixel is also half of the amount represented by a level.

If on its own an input value would be rounded up, then the maximum effect that a positive total incoming error can have on the error is to select the same output value but pass on a positive rather than negative error. Here, the error is still only as much as one half a level of error. If an input value would round down, then the most a positive error can do is to move the level up by one and then propagate a negative error. Similarly for negative errors, the most change that can occur is that the output value is one level less than it would have been without any contributed error. So in all cases the output will always be at most one level different from the input, and whatever the input value and accumulated error, the absolute value of the error transferred out of a pixel even when the accumulated error is taken into account is half a level. Taking accumulated error into account does not cause the maximum possible error passed on to increase.

FIG. 3 is an illustration of how the error arising at a pixel P can be propagated both directly and indirectly to the neighboring pixel that is positioned down and to the right, i.e., pixel Q. The error arising from P propagated via A and B to Q will be 7/16×3/16, or approximately 0.082. Adding the results of similar calculations for all the error paths, and then considering that the error is at most initially half a level, permits the conclusion that 3607/32768 (approximately 11%) of a level is the maximum error that Q will receive from P. By the time the error is propagated to pixel R in FIG. 3, the maximum error contributed by P is less than 10% of the error level. In accordance with the invention, error levels of this level are ignored.

When screening a complete page or image, discarding small errors in this way permits the storage and later propagation of an error array for each independently calculated area that is no larger than one pixel more than a scan line. It also permits the recalculation and reapplication of the error that arises from a small part of a scene to a specific small area as well as the immediate neighboring pixels.

In particular, for a common case where an image page is divided into horizontal sections (e.g., bands), the unadjusted values for each band can be computed independently, and therefore in parallel. In this case, the initial error array is computed at the same time. Once the computation is performed, the error is diffused through the band by way of an independent process that can lag behind the first process by an amount that is equal to the maximum error size permitted by the error array.

Furthermore, by discarding small errors, the effect of the error array is limited to a little more than a single line. As a result, storage of the accumulated errors at the band boundaries is all that is required to determine the error. In certain embodiments of the invention, the effects of neighboring bands are applied at a later point in time based on the stored accumulated errors at the band boundaries. As a result, the independent processing of a majority of screening bands is permitted.

### BRIEF DESCRIPTION OF THE DRAWINGS

The present invention may be more readily understood by one skilled in the art with reference being had to the following detailed description of the preferred embodiments thereof, taken in conjunction with the accompanying drawings, and in which:

FIG. 1 is an illustration of the distribution of an error term between neighboring pixels in accordance with a prior art error diffusion algorithm;

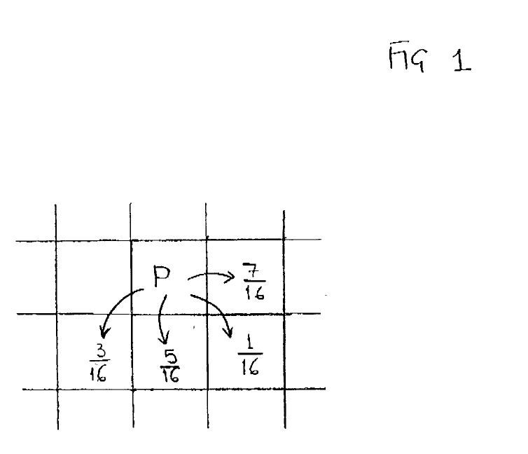

FIG. 2 is an illustration of a contribution of error terms to a pixel arising from neighboring pixels in accordance with the prior art;

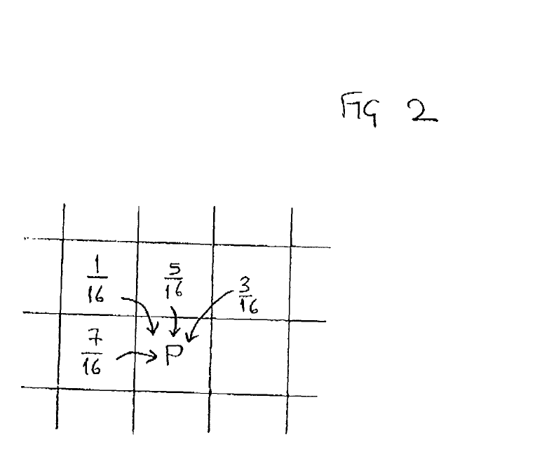

FIG. 3 is an illustration of the propagation of an error term both directly and indirectly to two nearby pixels;

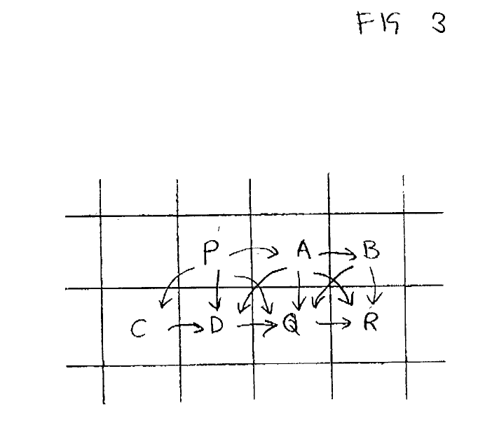

FIG. 4 is a flowchart illustrating the steps of a first method for independently performing error diffusion calculations in accordance with the invention; and

FIG. 5 is a flowchart illustrating the steps of a second method for independently performing error diffusion calculations based on the results of the method of FIG. 4.

### DETAILED DESCRIPTION OF THE EXEMPLARY EMBODIMENTS

The principal feature of the present invention is the division of error computations between two processes. In the present invention, the description of the exemplary embodiments uses terminology shared by the disclosed Floyd-Steinberg algorithm. However, in the contemplated embodiments of the invention, error_term is a broader term. That is, an error_term as presently used is an array that stores many error terms, as opposed to a term that is a simple single variable.

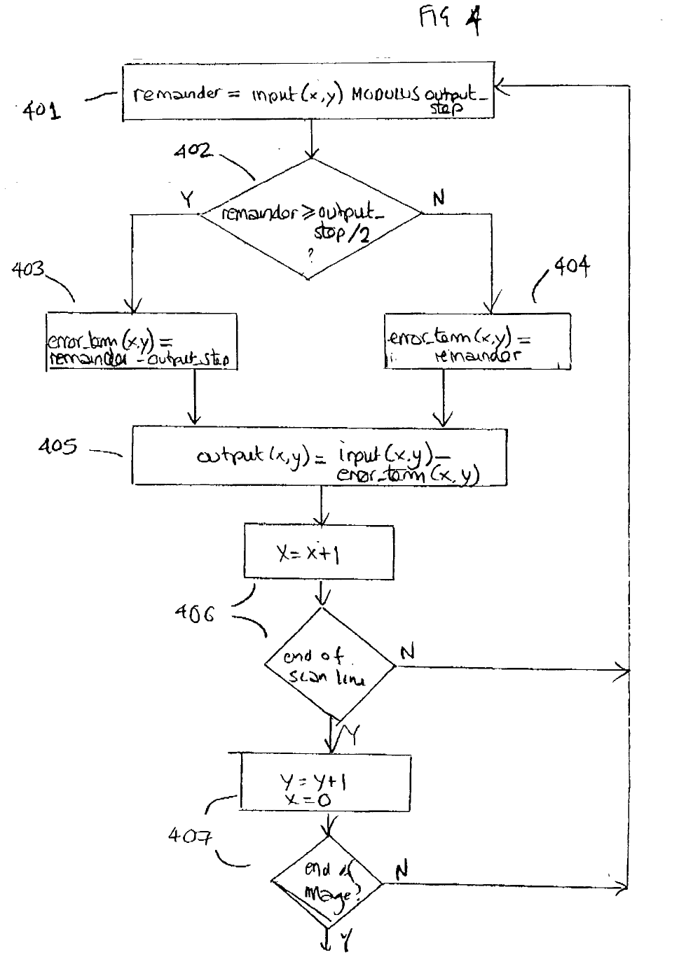

FIG. 4 is an illustration of the steps of a first process for independently performing error diffusion calculations in accordance with the invention. The first process of the invention is implemented by dividing a remainder when the input value from the original image is at a pixel with raster co-ordinates x, y by a mid-point of the steps between possible output values represented in the same range as the input values, as indicated in step 401.

A check is then made to determine whether the remainder is more than half way to the next error term, as indicated in step 402. If the remainder is more than half way to the next error term, then the error term for the pixel is calculated as an amount that is less than the next level up, which is negative, as indicated in step 403. If the remainder is less than half way to the next error term, then the error term is equated (i.e., made equal) to the remainder, as indicated in step 404.

Next, the error term is subtracted from the input to calculate the output value for the pixel at x, y, as indicated in step 405. This has the effect of quantizing the output to only those levels permitted in the output value. Because the error term may be negative (at step 403), the subtraction may increase the output to the next allowed level.

A check is then made to determine whether the end of a scan line has been reached, as indicated in step 406. If the end of the scan line has not occurred, then a return to step 401 occurs. If the end of a scan line has occurred, then a check is performed to determine whether the end of an image has occurred, as indicated in step 407. In this manner, the method of the invention is repeated across and down the image until all pixels are processed.

The prior steps of the first process are also implemented as shown in the following sequence, wherein

| | |
|---|---|
| (401) | remainder = input (x, y) MODULUS output_step |
| (402) | if remainder >= output_step / 2 then |

| | |
|---|---|
| (403) | error_term (x, y) = remainder − output_step |

else

| | |
|---|---|
| (404) | error_term (x, y) = remainder |

| | |
|---|---|
| (405) | output (x, y) = input (x, y) − error_term (x, y) |
| (406) | increment x and repeat from step 501 until end of scan line |
| (407) | increment y, reset x, and repeat from step 501 until end of |
| | image |

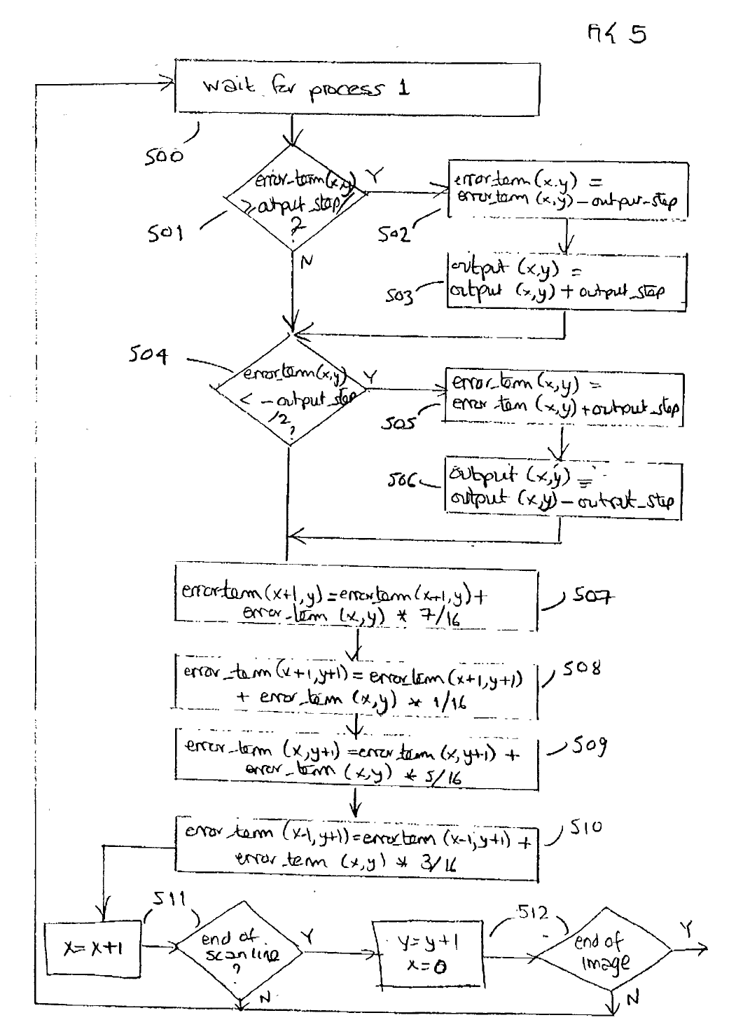

FIG. 5 is a flowchart illustrating the steps of a second process for independently performing error diffusion calculations based on the results of the process of FIG. 4. The two processes can overlap and proceed simultaneously. However, in accordance with the invention, the second process is not permitted to start processing a pixel until the first process has computed an initial tone value and error term for a pixel. Hence, a pause is initiated until data from the first process is ready for the pixel being considered, as indicated in step 500.

A check is made to determined whether the error term accumulated at a pixel would cause the output to be further adjusted by rounding up, as indicated in step 501. That is, a check is made to determine whether the error term is more than half way to the next level. If the error term is more than half way to the next level, then the error term is decreased by the necessary amount to compensate for increasing the output to the next allowed level, as indicated in step 502. The output is then increased to the next allowed level, as indicated in step 503.

A test that is opposite to the test performed in step 502 is now performed. Specifically, a check is made to determine whether the error term would cause the output to round down to the next allowed output level, as indicated in step 504. If the error term would cause the output to round down to the next allowed output level, the error term is increased by the necessary amount to compensate for decreasing the output to the next allowed level, as indicated in step 505. The output is then decreased to the next allowed level, as indicated in step 506.

The error remaining after any necessary output level adjustments are redistributed to neighboring pixels, as indicated in steps 507, 508, 509 and 510. In accordance with the invention, the distribution of the remaining error is in the ratio of 7/16 to the error term of the pixel below, 1/16 to the pixel below left, 5/16 to the right and 3/16 to the below right, respectively.

A check is now made to determine whether the end of a scan line has been reached, as indicated in step 511. If the end of the scan line has not occurred, then a return to step 500 occurs. If the end of a scan line has occurred, then a check is performed to determine whether the end of the image has occurred, as indicated in step 512. In this manner, the method of the invention is repeated across and down the image until all pixels are processed.

The prior steps of the second process are also implemented as shown in the following sequence, wherein

| | |
|---|---|
| (500) | wait until process 1 has completed pixel x,y |
| (501) | if error_term (x, y) >=output_step / 2 then |

| | |
|---|---|
| (502) | error_term (x, y) = error_term (x, y) − output_step |
| (503) | output (x, y) = output (x, y) + output_step |

| | |
|---|---|
| (504) | if error_term (x, y) <−output_step / 2 then |

| | |
|---|---|
| (505) | error_term (x, y) = error_term (x, y) + output step |
| (506) | output (x, y) = output (x, y) − output_step |

| | |
|---|---|
| (507) | error_term (x+1, y) = |

error_term (x+1, y) + error_term (x, y) * 7/16

| | |
|---|---|
| (508) | error_term (x+1, y+1) = |

error_term (x+1, y+1) + error_term (x, y) * 1/16

| | |
|---|---|
| (509) | error_term (x, y+1) = |

error_term (x, y+1) + error_term (x, y) * 5/16

| | |
|---|---|
| (510) | error_term (x−1, y+1) = |

error_term (x−1, y+1) + error_term (x, y) * 3/16

| | |
|---|---|
| (511) | increment x and repeat from step 500 until end of scan line |
| (512) | increment y, reset x, and repeat from step 500 until end of image |

Of note, the error_term array is not allocated such that it has one entry for each error term of a pixel. Instead, the error_term is an array that is one scan line plus one pixel long. Therefore, in accordance with the invention, at any iteration, error_term (x,y) will refer to an element in this fixed size array, and the indexes of neighboring pixels are calculated as offsets from that point into the array, wrapping around to the beginning as necessary. In preferred embodiments, the first process will also wait for the second process to calculate the error of the pixel.

A larger array, but still much less than a full page, permits the first process to wait less often for the second process, As a result, a greater amount of overlapping of the processes is permitted.

In accordance with the invention, the second process is also configured to operate over a portion of an image, as opposed to over the complete image. In alternative embodiments of the invention, other portions of the image are calculated independently with further instances of the second process to provide a greater amount of parallel processing, or only for the modified portion where changes are made only for the occurrence of small changes in a larger image. Further, when a scan line plus one pixel of error terms is carried over at some point in time into the adjacent independently-calculated portion before termination, a predetermined maximum percent of the error is lost when the revised error terms arising from that final adjustment are then discarded rather than propagated. In preferred embodiments of the invention, the maximum predetermined percentage of error is approximately 10%.

The method of the invention permits improved error diffusion screening. The method advantageously utilizes parallel processing. Small modifications are made to an image without the requirement to re-screen an entire image. As a result, the effect of an error array is limited to a little more than a single line.

While the invention has been particularly shown and described with reference to a preferred embodiment thereof, it will be understood by those skilled in the art that various changes in form and details may be made therein without departing from the spirit and scope of the invention. In addition, it should be understood that the separation of error distribution from the calculation thereof and the discarding of small amounts of error, is not limited to the specific distribution proportions of the method disclosed by Floyd Steinberg. The method of the invention is achievable with any appropriate error term distribution technique.

What is claimed is:

1. A method for error diffusion screening with parallel processing, comprising:
dividing a process for diffusing errors in output images into a plurality of processes;
performing a first process comprising the steps of:
calculating a tone value for an output pixel based on a corresponding input pixel value;
computing an error term for the output pixel based on a difference between input pixel values and output pixel values; and
generating an array of output pixels having output values that are closest to corresponding input values and an array of error terms for the output pixels; and
performing a second process, comprising the step of:
apportioning error values between neighboring pixels in the array of output pixels;
wherein the first and the second processes are performed simultaneously.

2. The method of claim 1, wherein the second process uses an error term for a specific pixel only after computation of the error term and tone value for the output pixel is completed by the first process.

3. The method of claim 1, wherein said step of calculating tone values comprises:
dividing a remainder value of a pixel when the input value from the original image is at a pixel having predetermined raster co-ordinates by a midpoint of steps between possible output values represented in a range that is identical to a range of input image values.

4. The method of claim 3, wherein the predetermined co-ordinates are x, y co-ordinates.

5. The method of claim 1, further comprising the step of:
checking to determining whether the remainder value is greater than one half of a value of the error term; and
calculating the error term for the pixel if the remainder is greater than one half the value of a next error term, otherwise equating the value of the error term to the value of the remainder.

6. The method of claim 5, wherein the error term for the pixel has a value that that is less than a value of a next upward level in the image.

7. The method of claim 5, wherein the error term has a negative value.

8. The method of claim 5, further comprising the step of:
quantizing an image output to levels that are permitted in the output value.

9. The method of claim 8, wherein said quantizing step comprises subtracting the error term from the input tone value to generate an output value at specific co-ordinates.

10. The method of claim 8, further comprising the step of:
determining whether an end of a scan line has been reached; and
determining whether an end of an image has been reached if the end of the scan line has been reached, otherwise incrementing a counter and returning to the step of calculating tone values.

11. The method of claim 1, wherein the apportioning step of said second process comprises the steps of:
pausing until the first process has completed computation of the tone value and the error term for the output pixel.

12. The method of claim 1, wherein the apportioning step of the second process comprises the steps of:
initiating a pause until data from the first process is ready for a pixel being considered;
determining whether an accumulated error term at a pixel would cause an additional adjustment of the output value;
decreasing the error term by a calculated amount to increase an output to a next permitted level in an image if the accumulated error term at a pixel would cause an additional adjustment of the output value; and
increasing the output to the next permitted level in the image.

13. The method of claim 12, wherein said determining step comprises assessing whether a value of the error term is greater than one half a value of the next upward level in the image.

14. The method of claim 12, further comprising the steps of:
determining whether the accumulated error term at the pixel would cause an additional adjustment of the output value;
increasing the error term by a calculated amount to compensate for decreasing the value output to the next permitted level in an image if the accumulated error term at the pixel would cause the additional adjustment of the output value; and
decreasing the output value to the next permitted level in the image.

15. The method of claim 14, further comprising the steps of:
redistributing any error that remains after adjusting output levels of neighboring pixels by a predetermined ratio.

16. The method of claim 15, wherein said predetermined ratio is 7/16 to an error term of a pixel below, 1/16 to an error term of a pixel below and left, 5/16 to an error term of a right pixel, and 3/16 to an error term of a pixel below and right.

17. The method of claim 15, further comprising the steps of:
determining whether an end of a scan line has been reached; and
determining whether an end of the image has occurred if the end of the scan line has occurred, otherwise returning to the step of pausing until the first process has completed computation of the tone value and the error term for the output pixel.
